(19) United States
(12) Patent Application Publication
(10) Pub. No.: US 2014/0365298 A1
(43) Pub. Date: Dec. 11, 2014

(54) SMART BUDGET RECOMMENDATION FOR A LOCAL BUSINESS ADVERTISER

(71) Applicants: Xinyu Tang, Cupertino, CA (US); Xuefu Wang, Los Altos, CA (US); Abhinav Jalan, Sunnyvale, CA (US); Ankur Jain, Mountain View, CA (US); Kiley McEvoy, San Francisco, CA (US); Bhavesh Mehta, Cupertino, CA (US)

(72) Inventors: Xinyu Tang, Cupertino, CA (US); Xuefu Wang, Los Altos, CA (US); Abhinav Jalan, Sunnyvale, CA (US); Ankur Jain, Mountain View, CA (US); Kiley McEvoy, San Francisco, CA (US); Bhavesh Mehta, Cupertino, CA (US)

(73) Assignee: GOOGLE INC., Mountain View, CA (US)

(21) Appl. No.: 13/223,394

(22) Filed: Sep. 1, 2011

Related U.S. Application Data
(60) Provisional application No. 61/387,051, filed on Sep. 28, 2010.

(51) Int. Cl. G06Q 30/00

(52) U.S. Cl. 705/14.48

(57) ABSTRACT

Spending data for local advertising campaigns for advertisements directed for a specific business location is analyzed in order to classify the campaigns by geographic location and type of each business. The server then determines the average and range of spending for a plurality of geographic and type classifications. This spending and classification data is stored by a server in order to identify reasonable and competitive budgets for other advertising campaigns. When an advertiser is interested in establishing a new campaign for a local business, the server may determine the classification for the business based on the location and type of the business. The server then retrieves the stored data in order to recommend one or more reasonable budgets for the advertiser.

### CROSS-REFERENCE TO RELATED APPLICATIONS

This application claims the benefit of the filing date of U.S. Provisional Patent Application No. 61/387,051 filed Sep. 28, 2010, the entire disclosure of which is hereby incorporated herein by reference.

### BACKGROUND

An advertiser may spend a significant amount of capital in order to ensure that Internet users see and click on the advertiser's advertisements. The advertiser hopes that the advertisement will capture the interest of the user and lead to a transaction between the advertiser and the user.

Auctions for displaying advertisements may be conducted by computing systems in real time. The advertiser may preselect bid values and spending budgets for a new advertising campaign, but at the time of selecting these bid values and spending budgets may not know how effective or competitive its choices will be.

Many systems which provide advertisers with assistance in setting bid and budget values for a particular advertising campaign may rely on an experimental period or past performance of the advertising campaign. In these examples, the sometimes inexperienced local business advertiser must arbitrarily identify a budget value in order to identify a recommended bid value. The advertising system may then identify a bid value based on the performance of the advertisement during the “experimental period.” Thus, the advertiser must spend time and money before being satisfied that the combination is, or will be, effective for the advertising campaign.

In order to assist advertisers in identifying reasonable budget and bid values, companies which provide advertising services may also record user behaviors which lead to an advertisement being displayed, often called an “impression,” as well as a user's response to the impression. One standard user behavior that is sometimes recorded is the click through rate (“CTR”). The CTR is the number of times an advertisement is displayed versus the number of times it is selected (clicked on) by a user. Another is the conversion rate (“CR”). Though based on ad impressions, actual CRs may be defined differently for each advertiser. For example, for one advertiser, a conversion may include visiting a website, visiting a website for a period of time, registering with a website, or making a purchase. This behavior information is generally reported to the company providing the advertising service by the advertiser. The CTR and CR information is then summarized and reported to the advertiser to assist in the evaluation of campaigns in order to optimize bid values and spending budgets. While the CTR and CR are indicative of the effectiveness of an advertising campaign, advertisers must still arbitrarily set initial budgets and wait for some period of time in order to determine the effectiveness or competitiveness of these values.

### BRIEF SUMMARY

Aspects of the disclosure relate generally to assisting advertisers to set and maintain reasonable advertising budgets for online advertising systems. More specifically, spending data for advertising campaigns associated with local businesses, or those advertising for a specific geographic location, is analyzed in order to classify the spending based on the geographic location and type of business. A server then determines the average and range of spending for a plurality of geographic locations and business type classification pairs. This spending and classification data is stored by the server in order identify reasonable and competitive budgets for other advertising campaigns. When an advertiser is interested in establishing a new campaign for a local business, the server may determine the classification for the business based on the location and type of the business. The server then retrieves the stored data in order to recommend one or more reasonable budgets for the advertiser. This allows the advertiser to identify a reasonable and competitive initial budget without having the time consuming and costly project of attempting to determine a budget experimentally over time.

One aspect of the disclosure provides a computer-implemented method. The method includes identifying a plurality of local advertising campaigns. Each local advertising campaign of the plurality of local advertising campaigns is associated with an actual spending amount indicative of an amount of money spent on advertising during a defined period of time, a category indicative of a type of product or service offering, and a geographic location. The method also includes identifying a set of geographic areas; for each particular geographic area of the set of geographic areas, determining an average spending value for the geographic area by averaging the actual spending amounts of at least some of the local advertising campaigns of the plurality of local advertising campaigns that are associated with a geographic location within the particular geographic area; classifying each particular geographic area of the set of geographic areas into one of a plurality of geographic area spending classifications based on the average spending value for the particular geographic area; and identifying a set of categories. Each category in the set of categories corresponds to a particular type of business product or service offering. The method also includes for each particular category of the set of categories, determining an average spending value for the particular category by averaging the actual spending amounts of at least some of the local advertising campaigns of the plurality of local advertising campaigns that are associated with the particular category; classifying each particular category of the set of categories into one or more category spending classifications based on the average spending value for the particular category; pairing each of the one or more geographic area spending classifications with each of the one or more category spending classifications to obtain a set of pairings such that each pairing of the set of pairings is associated with a set of local advertising campaigns of the plurality of local advertising campaigns; for each particular pairing of the set of pairings, determining, by a processor of a computer, a spending value for the particular pairing based on the actual spending amounts of the set of local advertising campaigns of the plurality of local advertising campaigns associated with the particular pairing; and storing the set of pairings and the spending values for the pairings in memory.

In one example, the method also includes receiving, from a second processor of a second computer, information identifying a geographic location of a business and a category of the business; accessing the stored set of pairings; identifying a pairing of the stored set of pairings based on the received information; determining a recommended budget based on the one or more spending values associated with the identified pairing; and transmitting the recommended budget to the second computer for display on a display of the second computer. In one alternative, the method includes transmitting the determined pairing to the second computer for presentation on the display of the second computer. In another alternative, each advertising campaign of the plurality of local advertising campaigns may also be associated with a budget value and the recommended budget is based on a padding factor defined as an average ratio of a budget value to a spending value of a selected group of the plurality of local advertising campaigns. The selected group of the plurality of local advertising campaigns may include the advertising campaigns of the plurality of advertising campaigns within the received category. The selected group of the plurality of local advertising campaigns may include all advertising campaigns of the plurality of advertising campaigns within the same geographic area as the received geographic location.

Another aspect of the disclosure provides a computer implemented method. The method includes receiving, from a processor of a computer, information identifying a geographic location of a business and a category of the business; identifying stored advertising data based on the received information, the advertising data being associated with a spending value, a geographic area spending classification, and a category spending classification; determining, by a processor, a recommended budget based on the spending values associated with the identified data; and transmitting the recommended budget to the computer for presentation on a display of the computer.

In one example, the identified advertising data is a paring of stored set of parings generated by identifying a plurality of local advertising campaigns, each local advertising campaign of the plurality of local advertising campaigns being associated with an actual spending amount indicative of an amount of money spent on advertising during a defined period of time, a category indicative of a type of product or service offering, and a geographic location; identifying a set of geographic areas; for each particular geographic area of the set of geographic areas, determining an average spending value for the geographic area by averaging the actual spending amounts of at least some of the local advertising campaigns of the plurality of local advertising campaigns that are associated with a geographic location within the particular geographic area; classifying each particular geographic area of the set of geographic areas into one of a plurality of geographic area spending classifications based on the average spending value for the particular geographic area; identifying a set of categories, each category in the ser of categories corresponding to a particular type of business product or service offering; for each particular category of the set of categories, determining an average spending value for the particular category by averaging the actual spending amounts of at least some of the local advertising campaigns of the plurality of local advertising campaigns that are associated with the particular category; classifying each particular category of the set of categories into one or more category spending classifications based on the average spending category value for the particular category; pairing each of the one or more geographic area spending classifications with each of the one or more category spending classifications to obtain a set of pairings such that each pairing of the set of pairings is associated with a set of local advertising campaigns of the plurality of local advertising campaigns; for each particular pairing of the set of pairings, determining, by a second processor of a second computer, a spending value for the particular paring based on the actual spending amounts of the set of local advertising campaigns of the plurality of local advertising campaigns associated with the particular pairing; and storing the set of pairings and the spending values for the parings in the memory as the stored set of parings. Each advertising campaign of the plurality of local advertising campaigns is associated with a budget value, and the recommended budget is based on a padding factor defined as the average ratio of a budget value to a spending value of a second plurality of the plurality of local advertising campaigns. The second plurality of the plurality of local advertising campaigns includes the advertising campaigns of the plurality of advertising campaigns within the received category. In one alternative, the second plurality of the plurality of local advertising campaigns may include the advertising campaigns of the plurality of advertising campaigns within the same geographic area as the received geographic location.

A further aspect of the disclosure provides a device. The device includes memory storing a stored set of pairings, each paring being associated with one or more pairing spending values, a geographic area spending classification, and a category spending classification. The device also includes a processor coupled to the memory. The processor being operable to receive, from a processor of a second device, information identifying a geographic location of a business and a category of the business; identify a pairing of the stored set of pairings by comparing the received information with the geographic area spending classifications and category spending classifications of the plurality of pairings; determine a recommended budget based on the one or more spending values associated with the identified pairing; and transmit the recommended budget to the second device for presentation on a display thereof.

In one example, the processor is operable to generate the stored set of parings by identifying a plurality of local advertising campaigns, each local advertising campaign of the plurality of local advertising campaigns being associated with an actual spending amount indicative of an amount of money spent on advertising during a defined period of time, a category indicative of a type of product or a service offering, and a geographic location; identifying a set of geographic areas; for each particular geographic area of the set of geographic areas, determining an average spending value for the geographic area by averaging the actual spending amounts of at least some of the local advertising campaigns of the plurality of local advertising campaigns that are associated with a geographic location within the particular geographic area; classifying each particular geographic area of the set of geographic areas into one of a plurality of geographic area spending classifications based on the average spending value for the particular geographic area; identifying a set of categories, each category in the set of categories corresponding to a particular type of business product or service offering; for each particular category of the set of categories, determining an average spending value for the particular category by averaging the actual spending amounts of at least some of the local advertising campaigns that are associated with the particular category; classifying each particular category of the set of categories into one or more category spending classifications based on the average spending category value for the particular category; pairing each of the one or more geographic area spending classifications with each of the one or more category spending classifications to obtain the set of pairings such that each pairing of the set of pairings is associated with a set of local advertising campaigns of the plurality of local advertising campaigns; for each particular pairing of the set of pairings, determining, by a second processor of a second computer, the spending value for the particular paring based on the actual spending amounts of the set of local advertising campaigns of the plurality of local advertising campaigns associated with the particular pairing; and storing the set of pairings and the spending values for the pairings in the memory as the stored set of parings. Each advertising campaign of the plurality of local advertising campaigns is associated with a budget value, and the recommended budget is based on a padding factor defined as the average ratio of a budget value to a spending value of a second plurality of the plurality of local advertising campaigns. The second plurality of local advertising campaigns includes the advertising campaigns of the plurality of advertising campaigns within the received category. In an alternative, the second plurality of local advertising campaigns includes the advertising campaigns of the plurality of advertising campaigns within the same geographic area as the received geographic location.

Still another aspect of the disclosure provides a device. The device includes memory storing a plurality of local advertising campaigns, each local advertising campaign of the plurality of local advertising campaigns being associated with a spending value, a category and a geographic location. The device also includes a processor coupled to the memory. The processor is operable to identify a set of geographic areas; for each particular geographic area of the set of geographic areas, determine an average spending value for the geographic area by averaging the actual spending amounts of at least some of the local advertising campaigns of the plurality of local advertising campaigns that are associated with a geographic location within the particular geographic area; classify each particular geographic area of the set of geographic areas into one of a plurality of geographic area spending classifications based on the average spending value for the particular geographic area; identify a set of categories, each category in the set of categories corresponding to a particular type of business product or service offering; for each particular category of the set of categories, determine an average spending value for the particular category by averaging the actual spending amounts of at least some of the local advertising campaigns of the plurality of local advertising campaigns that are associated with the particular category; classify each particular category of the set of categories into one or more category spending classifications based on the average spending value for the particular category; pair each of the one or more geographic area spending classifications with each of the one or more category spending classifications to obtain a set of pairings such that each pairing of the set of pairings is associated with a set of local advertising campaigns of the plurality of local advertising campaigns; for each particular pairing of the set of pairings, determine a spending value for the particular pairing based on the actual spending amounts of the set of local advertising campaigns of the plurality of local advertising campaigns associated with the particular pairing; and store the set of pairings and the one or more spending values in memory.

In one example, the processor is also operable to receive, from a second processor of a second device, information identifying a geographic location of a business and a category of the business; access the stored set of pairings from the memory; identify a pairing of the stored set of pairings based on the received information; determine a recommended budget based on the one or more spending values associated with the identified pairing; and transmit the recommended budget to the second device for presentation thereon. Each advertising campaign of the plurality of local advertising campaigns is associated with a budget value, and the processor is also operative to determine the recommended budget based on a padding factor defined as an average ratio of a budget value to a spending value of a selected group of the plurality of local advertising campaigns. The selected group of the plurality of local advertising campaigns includes the advertising campaigns of the plurality of advertising campaigns within the received category.

Still another aspect of the disclosure provides a non-transitory, tangible, computer-readable storage medium on which computer readable instructions of a program are stored, the instructions, when executed by a processor, cause the processor to perform a method. The method includes receiving, from a processor of a device, information identifying a geographic location of a business and a category of the business; accessing a stored set of pairings, each paring being associated with one or more pairing spending values, a geographic area spending classification, and a category spending classification; identifying a pairing of the stored set of pairings by comparing the received information with the geographic area spending classifications and category spending classifications of the plurality of pairings; determining a recommended budget based on the one or more spending values associated with the identified pairing; and transmitting the recommended budget to the device for presentation on a display thereof.

Yet another aspect of the disclosure provides a non-transitory tangible computer-readable storage medium on which computer readable instructions of a program are stored, the instructions, when executed by a processor, cause the processor to perform a method. The method includes identifying a plurality of local advertising campaigns, each local advertising campaign of the plurality of local advertising campaigns being associated with an actual spending amount indicative of an amount of money spent on advertising during a defined period of time, a category indicative of a type of product or service offering, and a geographic location; identifying a set of geographic areas; for each particular geographic area of the set of geographic areas, determining an average spending value for the geographic area by averaging the actual spending amounts of at least some of the local advertising campaigns of the plurality of local advertising campaigns that are associated with a geographic location within the particular geographic area; classifying each particular geographic area of the set of geographic areas into one of a plurality of geographic area spending classifications based on the average spending value for the particular geographic area; identifying a set of categories, each category in the set of categories corresponding to a particular type of business product or service offering; for each particular category of the set of categories, determining an average spending value for the particular category by averaging the actual spending amounts of at least some of the local advertising campaigns of the plurality of local advertising campaigns that are associated with the particular category; classifying each particular category of the set of categories into one or more category spending classifications based on the average spending value for the particular category; pairing each of the one or more geographic area spending classifications with each of the one or more category spending classifications to obtain a set of pairings such that each pairing of the set of pairings is associated with a set of local advertising campaigns of the plurality of local advertising campaigns; for each particular pairing of the set of pairings, determining a spending value for the particular pairing based on the actual spending amounts of the set of local advertising campaigns of the plurality of local advertising campaigns associated with the particular pairing; and storing the set of pairings and the spending values for the pairings in memory.

### BRIEF DESCRIPTION OF THE DRAWINGS

FIG. 1 is a functional diagram of a system in accordance with an exemplary embodiment.

FIG. 2 is a pictorial diagram of the system of FIG. 1.

FIG. 3 is a flow diagram in accordance with an exemplary embodiment.

FIG. 4 is a screen shot in accordance with an exemplary embodiment.

FIG. 5 is another screen shot in accordance with an exemplary embodiment.

FIG. 6 is a further screen shot in accordance with an exemplary embodiment.

FIG. 7 is a flow diagram in accordance with an exemplary embodiment.

### DETAILED DESCRIPTION

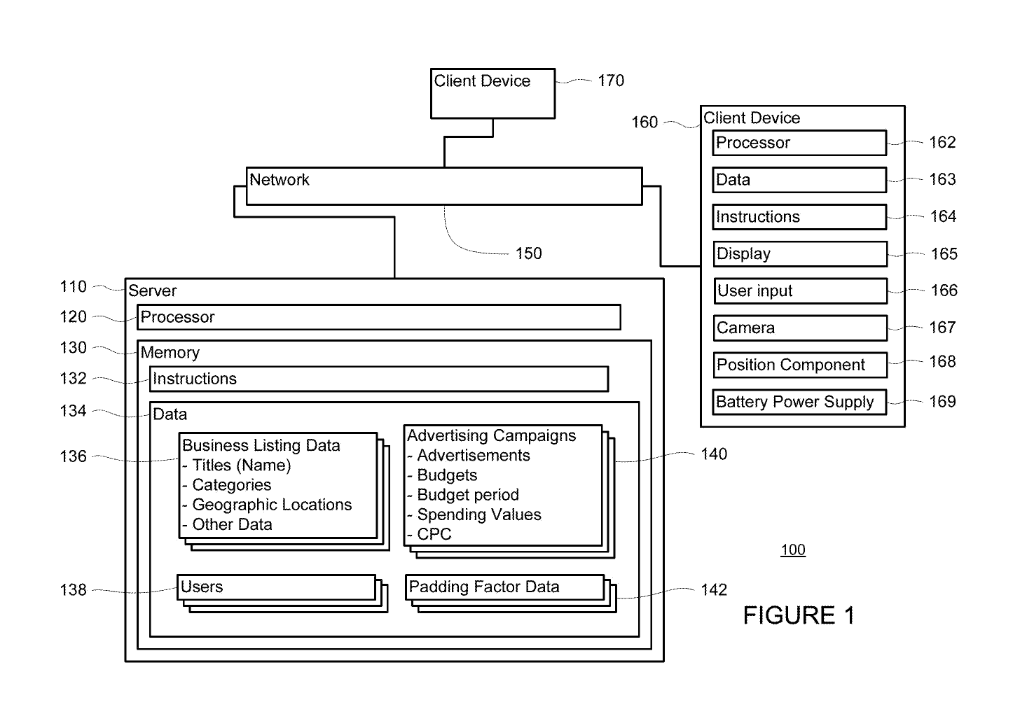

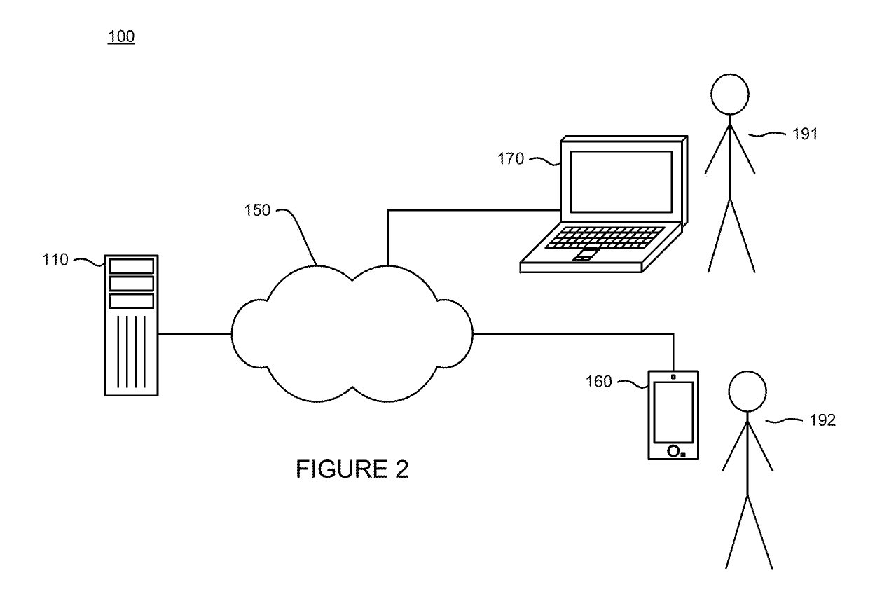

As shown in FIGS. 1-2, a system 100 in accordance with one aspect of the disclosure includes a computer 110 containing a processor 120, memory 130 and other components typically present in general purpose computers.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as a commercially available CPU. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, computer, or memory will be understood to include references to a collection of processors, computers, or memories that may or may not operate in parallel.

The computer 110 may be at one node of a network 150 and capable of directly and indirectly receiving data from other nodes of the network. For example, computer 110 may comprise a web server that is capable of receiving data from client devices 160 and 170 via network 150 such that server 110 uses network 150 to transmit and display information to a user on display 165 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1-2, it should be appreciated that a typical system can include a large number of connected computers.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or any other electrical device that is operable to display information), end user input 166 (e.g., a mouse, keyboard, touch-screen or microphone). The client device may also include a camera 167, accelerometer, speakers, a network interface device, a battery power supply 169 or other power source, and all of the components used for connecting these elements to one another.

As shown in FIG. 1, the client devices may also include geographic position component 168, to determine the geographic location of the device. For example, client device 170 may include a GPS receiver to determine the device's latitude, longitude and altitude position. Thus, as the client device changes location, for example by being physically moved, the GPS receiver may determine a new current location. The component 168 may also comprise software for determining the position of the device based on other signals received at the client device 170, such as signals received at a cell phone's antennas from one or more cell phone towers if the client device is a cell phone.

Although the client devices 160 and 170 may each comprise a full-sized personal computer, they may alternatively comprise mobile devices capable of wirelessly exchanging data, including position information derived from position component 168, with a server over a network such as the Internet. By way of example only, client device 160 may be a wireless-enabled PDA or a cellular phone capable of obtaining information via the Internet. The user may input information using a small keyboard, a keypad, or a touch screen.

Data 134 of server 110 may include business listing data 136 identifying various businesses. This information may be compiled from a plurality of data providers, such as the businesses themselves, business listing websites, or data contributed by users or other third parties. Thus, a particular business may be associated with one or a plurality of business listings. A business listing may be associated with a name or title (such as “Tom's Pizzaria”), a geographic location (such as “123 Main Street” or latitude and longitude), and various other types of information. Each business listing may also be associated with a category. For example, the “category” or “business category” of a business listing (or the business itself) may refer to the type of product(s) and/or service(s) offered by the business (such as “pizza”, “Italian restaurant,” “ballpark,” “salon,” etc.). As the titles and categories may be generated by the individual data provider, business, or detected by the server itself, it will be understood that the categories for the most part may not be standardized. Thus, the server may need to re-categorize or check the accuracy of a category by verifying the data through user reviews, information received from the business (an owner or representative), or third party information. A business listing may also be associated with links to the business's website, user reviews, images, phone numbers, links to additional information pages, etc.

Data 134 may include user data 138. The user data may identify users of the systems, e.g., any entity that interacts with system 100 such as businesses or people. For example, one user may be the owner of a gym named “X Gym”.

At least some users (e.g., “advertisers”) may be associated with advertising campaigns 140. An advertising campaign may be associated with one or more advertisements that the advertiser would like to have rendered to other users. Each advertisement, in turn, may be associated with content (information that the advertiser has indicated an interest in being rendered to other users) and a search term, or keyword, by which the content may be retrieved. For instance, the owner of “X Gym” may have stored an advertisement having the text content “X Gym—a great gym at a great price” and associated the advertisement with the keyword “exercise.”

Each advertisement may also be associated with budget and past spending values. The budget may be defined as the maximum amount of capital that an advertiser is willing to spend for a particular period of time, such as a day, week, month, year, etc. The spending values may be what the advertiser has spent for the previous, or several of the previous, budget periods. For example, the spending value may be based on the number of events for a particular advertisement times the price for the event. For ease of explanation, this description may refer to the price as a cost-per-click (“CPC”), namely, the price that the advertiser is willing to pay each time a user selects the advertisement. However, in lieu of CPC, it will be understood that the systems and methods described below may be used in connection with any pricing scheme, such as charging an advertiser each time the content is displayed to a user in response to the user entering in a search term that at least partially matches the advertisement's keyword (e.g., cost-per-view or cost-per-impression), each time a product or service is subsequently purchased by a user that viewed the advertisement (e.g., cost-per-action), and/or each time a quantity of qualifying events occur (cost-per-mille). An advertiser may thus select bid values for an advertisement based on the CPC, cost-per-view, cost-per-action, etc. While aspects of the disclosure may be particularly advantageous when used in connection with advertising, the uses described herein in connection with advertisements may be applied to other types of content as well.

The combination of at least one advertisement, associated advertising content, and various values (budget, budget period, maximum bid, and/or past spending values) may constitute an advertising campaign. At least some advertising campaigns may be local advertising campaigns. A local advertising campaign may include advertisements for a particular geographic business location. By contrast, a chain business advertisement is an advertisement for a business having multiple locations that are in different geographic areas and that does not pertain to a specific geographic location.

Data 134 may also include padding factor data 142. A padding factor may be considered the overall ratio of a budget for advertising campaigns to the actual spending of those advertising campaigns. For example, if an advertiser selects a budget for a particular period, the total actual spending may be determined based on the bid values for one or more advertisements and the number of times the advertisement is displayed (impressions) and/or selected (clicks). For example, for every $100 of budget, a particular advertiser may on average spend only $80 or 80% of the total. This percentage (S) of the average total budget spent may be used to define the padding factor as 1/S. Thus, if S is 80% or 0.8, the padding factor would be 125% or 1.25.

The padding factor may be calculated from all local advertisers or based on more specific data such as the category and/or the geographic location of the business. In one example, the server may calculate a padding factor using aggregated budget and actual spending data from all (or a subset) of the local business advertisement campaigns associated with the same category across some large region, such as the United States or Europe. In another example, the server may calculate a padding factor for all (or a subset) of the local business advertisements in a geographic area, such as for all (or a subset) of the business listings associated with a geographic location within a particular city, irrespective of the businesses' categories. In another example, the server may calculate a padding factor by taking into account businesses associated with the same category and geographic location.

In addition to the operations described below and illustrated in the figures, various operations will now be described. It should also be understood that the following operations do not have to be performed in the precise order described below. Rather, various steps can be handled in a different order or simultaneously and steps may be added or omitted.

The server 110 may identify local business advertisers associated with local advertising campaigns. For example, the server may compare the advertising data with the local listing data to identify local business listings that have advertising accounts. In some examples, the server may identify or select advertisers associated with a single business location in order to avoid including business listings for chain businesses which may have advertising campaigns directed towards different business locations in different cities, but do not target a specific geographic location.

The server may also identify the spending data for the identified local advertisers. This may include, for example, the total overall spending for an advertising campaign, or how much the advertiser spent over the budget period. The spending data may also include the advertiser's budget as well as the number of clicks and/or advertisement impressions for the local advertisement.

Using the identified data, the server may determine average advertising information (e.g., average actual advertising spending) for a plurality of advertising campaigns for local businesses in a particular geographic area. The geographic area may be defined as a city, county, state, country, or other relevant geographical division. For example, although not necessary, the geographic areas may be selected or determined such that the average spending for the area are a reasonable representation of all of the businesses in the area, or rather are associated with a low standard deviation. The businesses may include all types of businesses, and thus need not be limited to a particular category or type. For example, the server may determine an average per campaign spending value for advertising campaigns for all of the local advertisers in a particular city. The server may also determine the average number of clicks and/or advertisement impressions for each geographic area. This data may be used to estimate the number of clicks for a particular budget of an advertisement in a geographic area.

Based on the average geographic advertising information, the server may classify geographic areas into various classes. For example, the server may classify cities into “high-city”, “medium-city”, and “low-city” classes based on the average per campaign spending value for the cities. Cities where average per campaign spending value is relatively higher may be classified as medium-city or high-city, whereas a city where the average per campaign spending value is relatively lower may be classified as a low-city. For example, New York City, New York, may be considered a high-city, San Francisco, Calif. may be considered a medium-city, and College Station, Tex. may be considered a low-city.

By using the average per campaign spending value as a classifier, the classification may result in identifying advertising campaigns that are similar across the same class. For example, all advertising campaigns in the low-city class may have similar average per campaign spending values. The same may also be true for the other classifications, e.g., medium-city and high-city. Using these classifications, once the server identifies a city for a new advertising campaign, the server may also identify the overall spending of similarly situated advertising campaigns more accurately.

The cities, counties, states, or other geographic divisions may be classified in various other ways, including for example, by population, total advertising spending, etc. Again, by identifying the classification of a new advertising campaign, the server may identify the characteristic spending and bid data for similarly situated advertising campaigns.

The server may also determine the average per campaign spending value for all or a subset of the local business advertising campaigns by the types or the categories associated with the local business' listings. Here, the server 110 need not take into consideration the geographic location of a particular business, but may consider the amount of spending on advertising campaigns and type of business. The resulting data may include the average spending values for advertising campaigns in each category as well as a range of CPC for the category.

The range of CPC for a category may be important because advertisers in the same category may tend to have similar bids and CPCs. The data may also be used to estimate the number of clicks for a particular budget of an advertisement in a known business category.

Based on the average per campaign spending per category information, the server may classify business categories (or types) into various spending categories. For example, the server may classify business categories into “high-cat”, “medium-cat”, and “low-cat” classes based on the average per campaign spending value for the particular category. For example, the category “injury attorneys” may be classified as high_cat as it may have a higher advertising campaign budget and thus higher spending. A category such as “beauty salons” may be classified as low_cat as it may have a lower campaign budget and thus lower spending.

The result of these classifications is that each local business listing may be assigned to a geographic location and business listing category pairing. For example, using the three category examples above, each local business listing may be assigned into one of the nine cells of TABLE 1 below.

TABLE 1
Budget Cells, Geographic Location versus Classification

| | Low_Cat | Medium_Cat | High_Cat |
|---|---|---|---|
| Low_City | low_city/ | low_city/ | low_city/ |
| | low_cat | medium_cat | high_Cat |
| Medium_City | Medium_city/ | medium_city/ | medium_city/ |
| | low_cat | medium_cat | high_cat |
| High_City | high_city/ | High_city/ | high_city/ |
| | low_cat | medium_cat | high_cat |

The server may then calculate the spending trend data for the pairing of each cell based on the assigned businesses. For example, for the low_city/low_cat cell, the server may calculate the average per campaign spending value for all of the listings which are located in low average spend cities and low average spend categories.

The server may also calculate the range of per campaign spending for all of the businesses of each particular cell. For example, the server may calculate spending data for the 25th percentile, 50th percentile (the average spending discussed above), and 75th percentile of spending for a particular cell. The server may make the same calculations for each of the remaining 8 cells.

Although only 9 cells are shown in the example above described in connection with Table 1, any number of cells, classes, and categories may be used. The number of cells may also increase the number of categories and/or classes increases. Similarly, the number of cells may decrease at the number of categories and/or classes decreases.

The server may store the average budget values, categories, and geographic areas associated with each cell in order to assist advertisers determine budgets for new advertising campaigns.

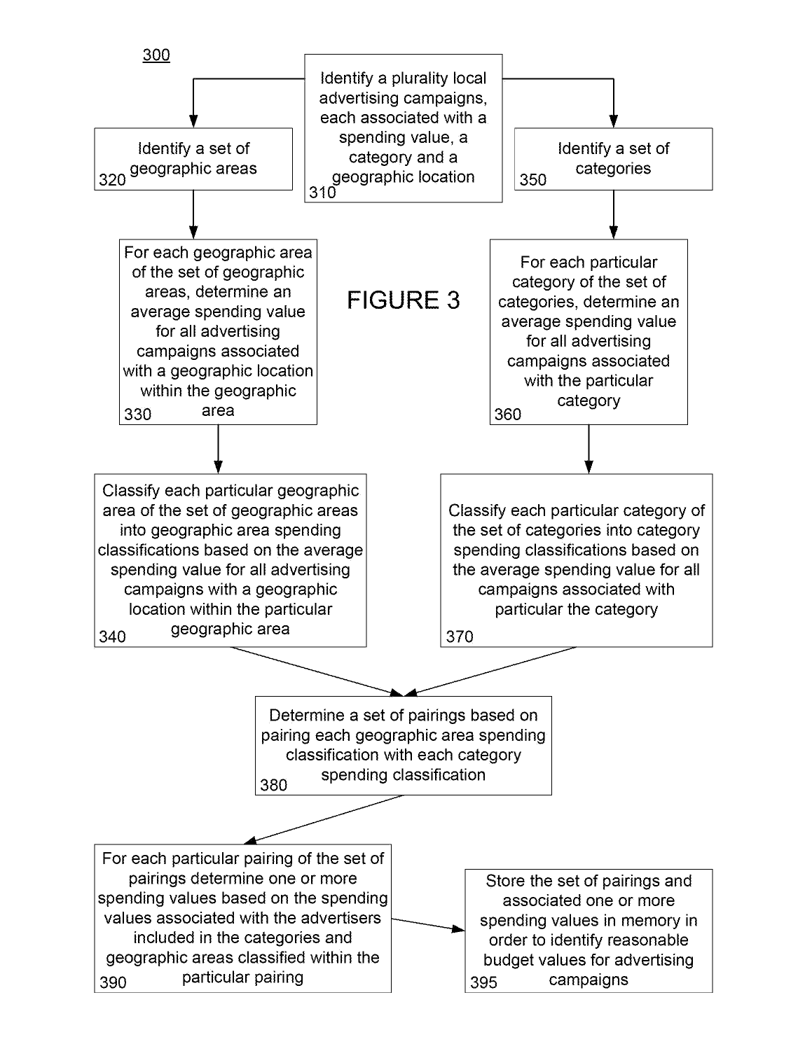

Process 300 of FIG. 3 is an overview of how the server may generate the cell data. As shown in block 310, the server identifies a plurality of local advertising campaigns. Each advertising campaign is associated with a spending value (a per campaign spending value), a category and a geographic location. At block 320, the server identifies a set of geographic areas such as a list of cities or other geographic divisions. At block 330, the server determines an average per campaign spending value for each geographic area. For example, as described above the average per campaign spending value may indicate (or estimate) an average amount of money spent per advertising campaign in each geographic area. The server then classifies each particular geographic area of the set of geographic areas into geographic area spending classifications based on the determined average spending values for those geographic areas at block 340.

The server also identifies a set of categories, or business types at block 350. The identification of categories may be done concurrently with identifying a set of geographic areas or these processes may be performed at separate times. For each particular category of the set of categories, the server determines an average spending value for all or a subset of all of the advertising campaigns associated with the particular category at block 360. Next, the server classifies each particular category of the set of categories into category spending classifications based on the average spending value for all of the campaigns associated with particular the category at block 370.

At block 380, the server determines a set of pairings (cells) based on pairing each geographic area spending classification with each category spending classification. For each particular pairing of the set of pairings, the server determines one or more spending values based on the spending values associated with the advertisers included in the categories and geographic areas classified within the particular pairing at block 390. Then, at block 395, the server stores the set of pairings and associated one or more spending values in memory in order to identify reasonable budget values for advertising campaigns.

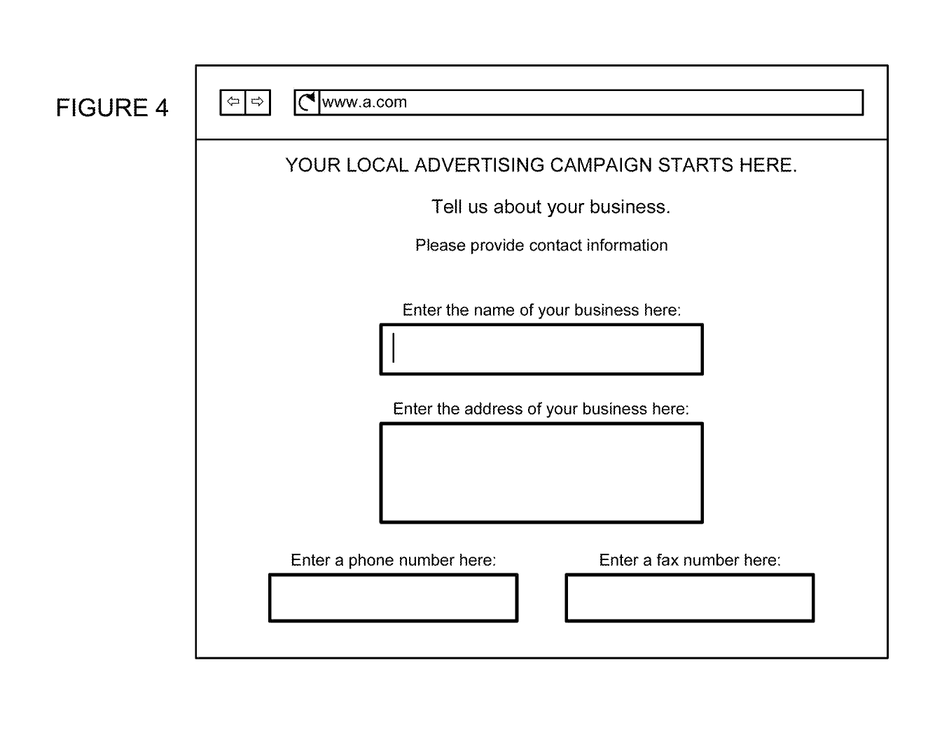

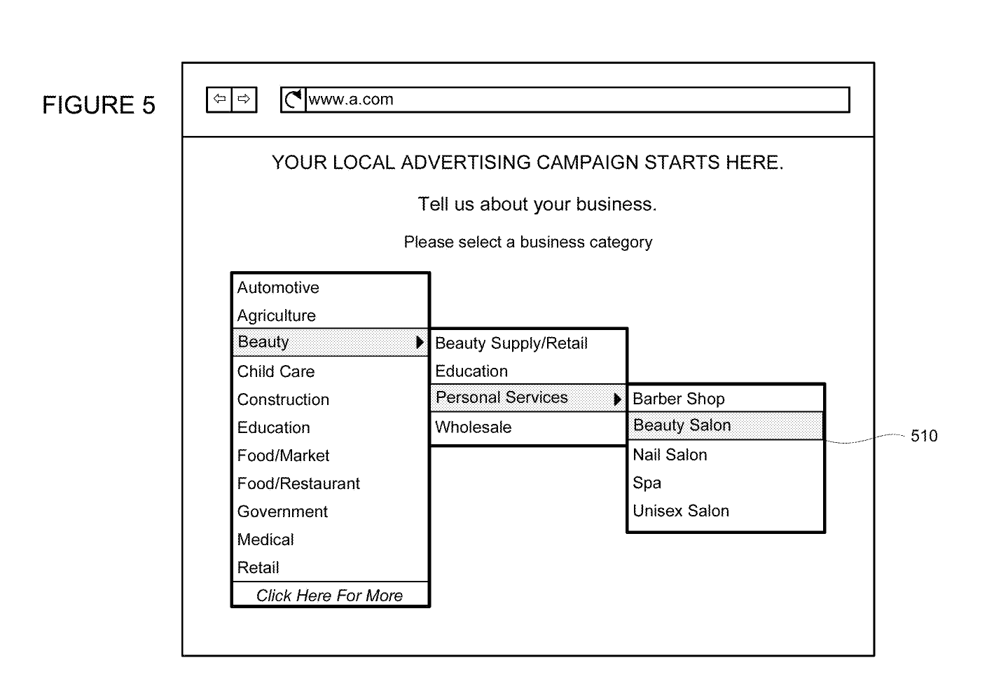

A user, or advertiser, attempting to set up a new advertising campaign may request assistance from the server in order to identify a reasonable budget. The advertiser may use a client device to enter information relating to the new campaign. This information may include various contact information for the local business including an address or other geographic location data as shown in exemplary screen shot 400 of FIG. 4. The advertiser may also input the category of the local business to the server, for example by entering information describing the type of business into a blank field or by selecting from pre-defined list of categories 510 as shown in exemplary screen shot 500 of FIG. 5.

Based on the information received from the advertiser, the server may determine the geographic and category classification for the new advertising campaign. Using the examples described above, if the business is a beauty salon located in New York City, New York, the server may identify the new advertising campaign as a low_cat based on the beauty salon category and a high_city based on its geographic location in New York City. Thus, this campaign would be associated with the low_cat/high_city budget cell. In another example, if the business is offers personal injury legal services in San Francisco, Calif., the server may identify the new advertising campaign as a high_cat based on the injury attorney category and a medium_city based on San Francisco. Thus, this campaign would be associated with in the high_cat/medium_city cell.

The server may then pull the relevant spending information for the associated cell. Again, this information may include the overall spending for businesses in various percentiles, such as the 25th, 50th, and 75th percentile of spending.

Using the spending information from the identified cell, the server may estimate one or more recommended budgets for the new campaign. For example, the server may recommend a budget based on the average or 50th percentile of spending for the cell. For each of the spending percentiles associated with the cells, the server may suggest a recommended budget. Thus if the cells are associated with three data points, the server may provide three recommended budgets, each recommended budget being associated with different levels of budgets and spending.

A recommended budget may be calculated based on one or more spending values of the identified cell and a padding factor as shown in the following equation:

recommended_budget=cell_spend×padding_factor.

For each recommended budget, the server may also determine an estimated number of clicks. The number of clicks may be estimated based on the following equation:

clicks=recommended_budget/cost_per_click

In this equation, the cost_per_click or CPC value may be determined based on the average CPC for advertisements associated with the same category of advertisements, the same geographic area, or a combination of the same category and geographic area. In this regard, the advertiser may be presented with an estimate of how effective a particular budget or budgets would be for the business.

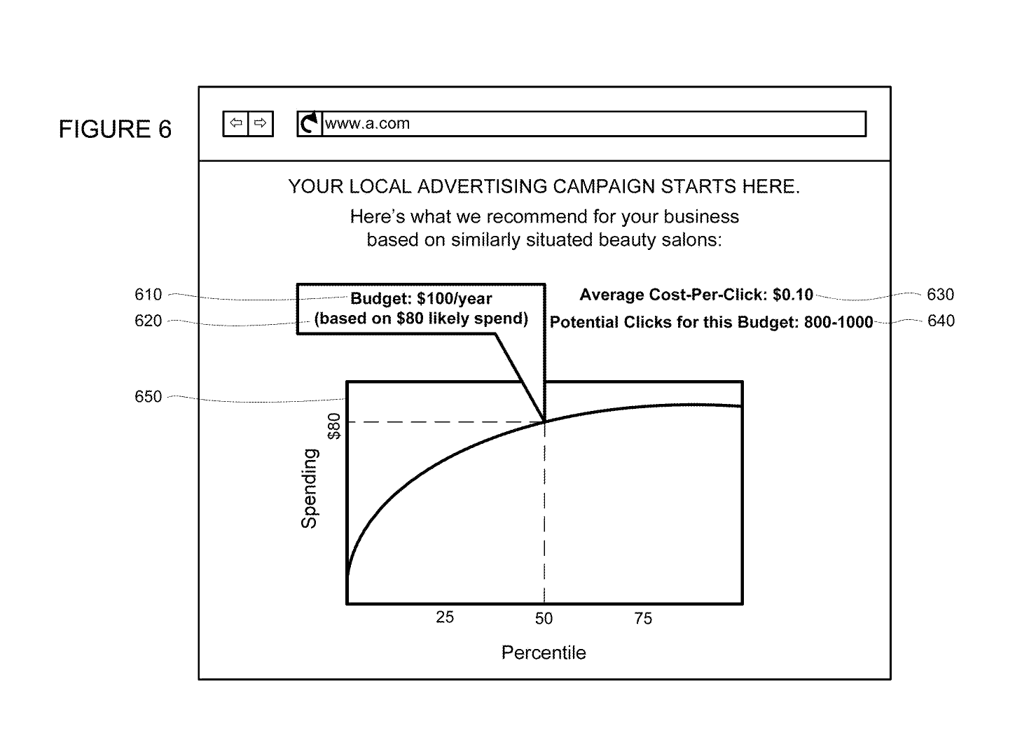

The recommended budget and estimated number of clicks information may then be transmitted to the advertiser's client device for display. For example, as shown in exemplary screen shot 600 of FIG. 6, the display may include the recommended budget and budget period 610, the likely spending value 620, the average cost per click data 630, as well as the potential number of clicks 640 for the recommended budget. Various methods of displaying the information may be used, including for example, a table or a graph 650 of average spending data for similarly situated businesses or those local businesses within the same category and geographic location pair.

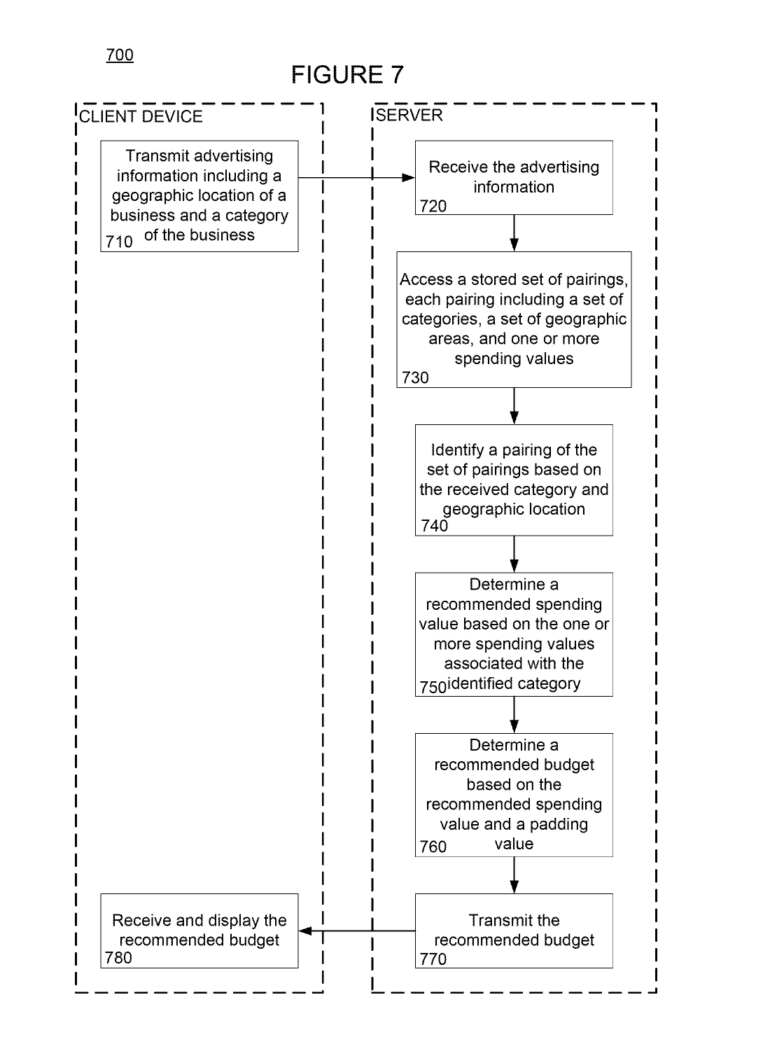

Process 700 of FIG. 7 is an overview of how the server may provide a recommended budget. As shown in block 710, a client device, operated by an advertiser or advertiser's representative, transmits advertising information for a new advertising campaign to a server. The advertising information includes a geographic location of a business and a category of the business. At block 720, the server receives the advertising information. The server then access a stored set of pairings at block 730 (see, for example, block 395 of FIG. 3). Each pairing includes a set of categories, a set of geographic areas, and one or more spending values. At block 740, the server identifies a pairing of the set of pairings based on the sets of categories and geographic areas associated with each of the pairing and the received advertising information, specifically the geographic location and category of the business. The server then determines a recommended spending value based on the one or more spending values associated with the identified category at block 750. Based on the recommended spending value and a padding value (discussed above), the server determines a recommended budget at block 760. The server then transmits the recommended budget to the client device at block 770, and the client device receives and displays the recommended budget.

Although the examples above may be used to determine an initial budget value for a new advertising campaign, the cell data and classification principals may also be used to establish reasonable budgets for existing campaigns in order to improve the overall effectiveness of the campaign.

The data analysis, including the classification of business categories and geographic locations may be performed using Google's MapReduce product as described in Jeffrey Dean and Sanjay Ghemawat's “MapReduce: Simplified Data Processing on Large Clusters,” OSDI'04: Sixth Symposium on Operating System Design and Implementation, San Francisco, Calif., (2004), and U.S. Pat. No. 7,650,331, the entire disclosures of which are hereby incorporated herein by reference.

As these and other variations and combinations of the features discussed above can be utilized without departing from the subject matter defined by the claims, the foregoing description of exemplary embodiments should be taken by way of illustration rather than by way of limitation of the subject matter defined by the claims. It will also be understood that the provision of examples (as well as clauses phrased as “such as,” “e.g.”, “including” and the like) should not be interpreted as limiting the claimed subject matter to the specific examples; rather, the examples are intended to illustrate only some of many possible aspects.

1. A computer-implemented method comprising:
identifying a plurality of local advertising campaigns, each local advertising campaign of the plurality of local advertising campaigns being associated with an actual spending amount indicative of an amount of money spent on advertising during a defined period of time, a category indicative of a type of product or service offering, and a geographic location;
identifying a set of geographic areas;
for each particular geographic area of the set of geographic areas, determining an average spending value for the geographic area by averaging the actual spending amounts of at least some of the local advertising campaigns of the plurality of local advertising campaigns that are associated with a geographic location within the particular geographic area;
classifying each particular geographic area of the set of geographic areas into one of a plurality of geographic area spending classifications based on the average spending value for the particular geographic area;
identifying a set of categories, each category in the set of categories corresponding to a particular type of business product or service offering;
for each particular category of the set of categories, determining an average spending value for the particular category by averaging the actual spending amounts of at least some of the local advertising campaigns of the plurality of local advertising campaigns that are associated with the particular category;
classifying each particular category of the set of categories into one or more category spending classifications based on the average spending value for the particular category;
pairing each of the one or more geographic area spending classifications with each of the one or more category spending classifications to obtain a set of pairings such that each pairing of the set of pairings is associated with a set of local advertising campaigns of the plurality of local advertising campaigns;
for each particular pairing of the set of pairings, determining, by a processor of a computer, a spending value for the particular pairing based on the actual spending amounts of the set of local advertising campaigns of the plurality of local advertising campaigns associated with the particular pairing; and
storing the set of pairings and the spending values for the pairings in memory.

2. The method of claim 1, further comprising:
receiving, from a second processor of a second computer, information identifying a geographic location of a business and a category of the business;
accessing the stored set of pairings;
identifying a pairing of the stored set of pairings based on the received information;
determining a recommended budget based on the one or more spending values associated with the identified pairing; and
transmitting the recommended budget to the second computer for display on a display of the second computer.

3. The method of claim 2, wherein:
each advertising campaign of the plurality of local advertising campaigns is associated with a budget value; and
the recommended budget is based on a padding factor defined as an average ratio of a budget value to a spending value of a selected group of the plurality of local advertising campaigns.

4. The method of claim 3, wherein the selected group of the plurality of local advertising campaigns includes the advertising campaigns of the plurality of advertising campaigns within the received category.

5. The method of claim 3, wherein the selected group of the plurality of local advertising campaigns includes all advertising campaigns of the plurality of advertising campaigns within the same geographic area as the received geographic location.

6. The method of claim 2, further comprising transmitting the determined pairing to the second computer for presentation on the display of the second computer.

7. A computer-implemented method comprising:
receiving, from a processor of a computer, information identifying a geographic location of a business and a category of the business;
identifying stored advertising data based on the received information, the advertising data being associated with a spending value, a geographic area spending classification, and a category spending classification;
determining, by a processor, a recommended budget based on the spending values associated with the identified data; and
transmitting the recommended budget to the computer for presentation on a display of the computer.

8. The method of claim 7 wherein the identified advertising data is a paring of stored set of parings generated by:
identifying a plurality of local advertising campaigns, each local advertising campaign of the plurality of local advertising campaigns being associated with an actual spending amount indicative of an amount of money spent on advertising during a defined period of time, a category indicative of a type of product or service offering, and a geographic location;
identifying a set of geographic areas;
for each particular geographic area of the set of geographic areas, determining an average spending value for the geographic area by averaging the actual spending amounts of at least some of the local advertising campaigns of the plurality of local advertising campaigns that are associated with a geographic location within the particular geographic area;
classifying each particular geographic area of the set of geographic areas into one of a plurality of geographic area spending classifications based on the average spending value for the particular geographic area;
identifying a set of categories, each category in the ser of categories corresponding to a particular type of business product or service offering;
for each particular category of the set of categories, determining an average spending value for the particular category by averaging the actual spending amounts of at least some of the local advertising campaigns of the plurality of local advertising campaigns that are associated with the particular category;
classifying each particular category of the set of categories into one or more category spending classifications based on the average spending category value for the particular category;
pairing each of the one or more geographic area spending classifications with each of the one or more category spending classifications to obtain a set of pairings such that each pairing of the set of pairings is associated with a set of local advertising campaigns of the plurality of local advertising campaigns;
for each particular pairing of the set of pairings, determining, by a second processor of a second computer, a spending value for the particular paring based on the actual spending amounts of the set of local advertising campaigns of the plurality of local advertising campaigns associated with the particular pairing; and
storing the set of pairings and the spending values for the parings in the memory as the stored set of parings.

9. The method of claim 8, wherein each advertising campaign of the plurality of local advertising campaigns is associated with a budget value, and wherein the recommended budget is based on a padding factor defined as the average ratio of a budget value to a spending value of a second plurality of the plurality of local advertising campaigns.

10. The method of claim 9, wherein the second plurality of the plurality of local advertising campaigns includes the advertising campaigns of the plurality of advertising campaigns within the received category.

11. The method of claim 9, wherein the second plurality of the plurality of local advertising campaigns includes the advertising campaigns of the plurality of advertising campaigns within the same geographic area as the received geographic location.

12. A device comprising:
memory storing a stored set of pairings, each paring being associated with one or more pairing spending values, a geographic area spending classification, and a category spending classification; and
a processor coupled to the memory, the processor being operable to:
receive, from a processor of a second device, information identifying a geographic location of a business and a category of the business;
identify a pairing of the stored set of pairings by comparing the received information with the geographic area spending classifications and category spending classifications of the plurality of pairings;
determine a recommended budget based on the one or more spending values associated with the identified pairing; and
transmit the recommended budget to the second device for presentation on a display thereof.

13. The device of claim 12, wherein the processor is operable to generate the stored set of parings by:
identifying a plurality of local advertising campaigns, each local advertising campaign of the plurality of local advertising campaigns being associated with an actual spending amount indicative of an amount of money spent on advertising during a defined period of time, a category indicative of a type of product or a service offering, and a geographic location;
identifying a set of geographic areas;
for each particular geographic area of the set of geographic areas, determining an average spending value for the geographic area by averaging the actual spending amounts of at least some of the local advertising campaigns of the plurality of local advertising campaigns that are associated with a geographic location within the particular geographic area;
classifying each particular geographic area of the set of geographic areas into one of a plurality of geographic area spending classifications based on the average spending value for the particular geographic area;
identifying a set of categories, each category in the set of categories corresponding to a particular type of business product or service offering;
for each particular category of the set of categories, determining an average spending value for the particular category by averaging the actual spending amounts of at least some of the local advertising campaigns that are associated with the particular category;
classifying each particular category of the set of categories into one or more category spending classifications based on the average spending category value for the particular category;
pairing each of the one or more geographic area spending classifications with each of the one or more category spending classifications to obtain the set of pairings such that each pairing of the set of pairings is associated with a set of local advertising campaigns of the plurality of local advertising campaigns;
for each particular pairing of the set of pairings, determining, by a second processor of a second computer, the spending value for the particular paring based on the actual spending amounts of the set of local advertising campaigns of the plurality of local advertising campaigns associated with the particular pairing; and
storing the set of pairings and the spending values for the pairings in the memory as the stored set of parings.

14. The device of claim 13, wherein each advertising campaign of the plurality of local advertising campaigns is associated with a budget value, and wherein the recommended budget is based on a padding factor defined as the average ratio of a budget value to a spending value of a second plurality of the plurality of local advertising campaigns.

15. The device of claim 14 wherein the second plurality of local advertising campaigns includes the advertising campaigns of the plurality of advertising campaigns within the received category.

16. The device of claim 14, wherein the second plurality of local advertising campaigns includes the advertising campaigns of the plurality of advertising campaigns within the same geographic area as the received geographic location.

17. A device comprising:
memory storing a plurality of local advertising campaigns, each local advertising campaign of the plurality of local advertising campaigns being associated with a spending value, a category and a geographic location; and
a processor coupled to the memory, the processor being operable to:
identify a set of geographic areas;
for each particular geographic area of the set of geographic areas, determine an average spending value for the geographic area by averaging the actual spending amounts of at least some of the local advertising campaigns of the plurality of local advertising campaigns that are associated with a geographic location within the particular geographic area;
classify each particular geographic area of the set of geographic areas into one of a plurality of geographic area spending classifications based on the average spending value for the particular geographic area;
identify a set of categories, each category in the set of categories corresponding to a particular type of business product or service offering;
for each particular category of the set of categories, determine an average spending value for the particular category by averaging the actual spending amounts of at least some of the local advertising campaigns of the plurality of local advertising campaigns that are associated with the particular category;
classify each particular category of the set of categories into one or more category spending classifications based on the average spending value for the particular category;
pair each of the one or more geographic area spending classifications with each of the one or more category spending classifications to obtain a set of pairings such that each pairing of the set of pairings is associated with a set of local advertising campaigns of the plurality of local advertising campaigns;
for each particular pairing of the set of pairings, determine a spending value for the particular pairing based on the actual spending amounts of the set of local advertising campaigns of the plurality of local advertising campaigns associated with the particular pairing; and
store the set of pairings and the one or more spending values in memory.

18. The device of claim 17, wherein the processor is further operable to:
receive, from a second processor of a second device, information identifying a geographic location of a business and a category of the business;
access the stored set of pairings from the memory;
identify a pairing of the stored set of pairings based on the received information;
determine a recommended budget based on the one or more spending values associated with the identified pairing; and
transmit the recommended budget to the second device for presentation thereon.

19. The device of claim 18, wherein:
each advertising campaign of the plurality of local advertising campaigns is associated with a budget value; and
the processor is further operable to determine the recommended budget based on a padding factor defined as an average ratio of a budget value to a spending value of a selected group of the plurality of local advertising campaigns.

20. The device of claim 19, wherein the selected group of the plurality of local advertising campaigns includes the advertising campaigns of the plurality of advertising campaigns within the received category.

21. A non-transitory, tangible, computer-readable storage medium on which computer readable instructions of a program are stored, the instructions, when executed by a processor, cause the processor to perform a method, the method comprising:
receiving, from a processor of a device, information identifying a geographic location of a business and a category of the business;
accessing a stored set of pairings, each paring being associated with one or more pairing spending values, a geographic area spending classification, and a category spending classification;
identifying a pairing of the stored set of pairings by comparing the received information with the geographic area spending classifications and category spending classifications of the plurality of pairings;
determining a recommended budget based on the one or more spending values associated with the identified pairing; and
transmitting the recommended budget to the device for presentation on a display thereof.

22. A non-transitory tangible computer-readable storage medium on which computer readable instructions of a program are stored, the instructions, when executed by a processor, cause the processor to perform a method, the method comprising:
identifying a plurality of local advertising campaigns, each local advertising campaign of the plurality of local advertising campaigns being associated with an actual spending amount indicative of an amount of money spent on advertising during a defined period of time, a category indicative of a type of product or service offering, and a geographic location;
identifying a set of geographic areas;
for each particular geographic area of the set of geographic areas, determining an average spending value for the geographic area by averaging the actual spending amounts of at least some of the local advertising campaigns of the plurality of local advertising campaigns that are associated with a geographic location within the particular geographic area;
classifying each particular geographic area of the set of geographic areas into one of a plurality of geographic area spending classifications based on the average spending value for the particular geographic area;
identifying a set of categories, each category in the set of categories corresponding to a particular type of business product or service offering;
for each particular category of the set of categories, determining an average spending value for the particular category by averaging the actual spending amounts of at least some of the local advertising campaigns of the plurality of local advertising campaigns that are associated with the particular category;
classifying each particular category of the set of categories into one or more category spending classifications based on the average spending value for the particular category;
pairing each of the one or more geographic area spending classifications with each of the one or more category spending classifications to obtain a set of pairings such that each pairing of the set of pairings is associated with a set of local advertising campaigns of the plurality of local advertising campaigns;
for each particular pairing of the set of pairings, determining a spending value for the particular pairing based on the actual spending amounts of the set of local advertising campaigns of the plurality of local advertising campaigns associated with the particular pairing; and
storing the set of pairings and the spending values for the pairings in memory.
